(19) United States
(12) Patent Application Publication
(10) Pub. No.: US 2018/0081425 A1
(43) Pub. Date: Mar. 22, 2018

(54) VIRTUAL AND AUGMENTED REALITY USING HIGH-THROUGHPUT WIRELESS VISUAL DATA TRANSMISSION

(71) Applicant: INTERNATIONAL BUSINESS MACHINES CORPORATION, ARMONK, NY (US)

(72) Inventors: Benjamin D. Briggs, Waterford, NY (US); Lawrence A. Clevenger, Rhinebeck, NY (US); Leigh Anne H. Clevenger, Rhinebeck, NY (US); Michael Rizzolo, Albany, NY (US); Aldis G. Sipolins, New York City, NY (US)

(21) Appl. No.: 15/270,122

(22) Filed: Sep. 20, 2016

(51) Int. Cl. G06F 3/01; G06T 7/00; H04B 10/116; A63F 13/25; A63F 13/327

(52) U.S. Cl. CPC G06F 3/012; G06T 7/004; H04B 10/116; H04L 65/60; A63F 13/327; G06T 2207/30196; A63F 13/25

(57) ABSTRACT

A computer-implemented method includes tracking, using a computer processor, a position of a receiver in real space. A set of images is generated, using the computer processor, where the set of images represents a position of the receiver in virtual space, and where the position of the receiver in virtual space corresponds to the position of the receiver in real space. The set of images is transmitted, using a light fidelity (LiFi) communication system, to a display.

### BACKGROUND

Embodiments of the present invention relate to virtual and augmented reality and, more specifically, to providing virtual and augmented reality using high-throughput wireless visual data transmission.

Conventional virtual reality (VR) and augmented reality (AR) systems include headset assemblies, which are worn by users and which display video in close proximity to each eye. Ideally, a headset assembly displays the video in a manner that provides high resolution and low latency, which is also referred to as motion-to-photon (MtP) latency. Although high resolution and low latency can contribute to a realistic experience, the failure to provide latency that is sufficiently low is a key factor in causing simulator sickness in a user. Specifically, for instance, achieving an MtP latency of less than 20 milliseconds (ms) is a known target for avoiding simulator sickness.

### SUMMARY

According to an embodiment of this disclosure, a computer-implemented method includes tracking, using a computer processor, a position of a receiver in real space. A set of images is generated, using the computer processor, where the set of images represents a position of the receiver in virtual space, and where the position of the receiver in virtual space corresponds to the position of the receiver in real space. The set of images is transmitted, using a light fidelity (LiFi) communication system, to a display.

In another embodiment, a system includes a memory having computer readable instructions and one or more processors for executing the computer readable instructions. The computer readable instructions include tracking a position of a receiver in real space. Further according to the computer readable instructions, a set of images is generated representing a position of the receiver in virtual space, where the position of the receiver in virtual space corresponds to the position of the receiver in real space. The set of images is transmitted, using a LiFi communication system, to a display.

In yet another embodiment, a computer program product for simulating a virtual environment includes a computer readable storage medium having program instructions embodied therewith. The program instructions are executable by a processor to cause the processor to perform a method. The method includes tracking a position of a receiver in real space. Further according to the method, a set of images is generated representing a position of the receiver in virtual space, where the position of the receiver in virtual space corresponds to the position of the receiver in real space. The set of images is transmitted, using a LiFi communication system, to a display.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a diagram of a display system, according to some embodiments of this invention;

FIG. 2 is a diagram of a space for operation of the display system, according to some embodiments of this invention;

FIG. 3 is another diagram of a space for operation of the display system, according to some embodiments of this invention;

FIG. 4 is a flow diagram of a method for simulating a virtual environment for a virtual or augmented reality, according to some embodiments of this invention; and

FIG. 5 is a block diagram of a computer system for implementing some or all aspects of the display system, according to some embodiments of this disclosure.

### DETAILED DESCRIPTION

According to some embodiments of the present invention, a display system for presenting virtual or augmented reality uses light fidelity (LiFi) communication to transmit visual data between a receiver and a processing system, such that high definition or ultrahigh definition data can be delivered to a user's eyes with low latency.

Conventionally, in a VR or AR system, visual data is captured by a headset and then transferred to a processing system for processing. This transfer can occur over a wired or wireless connection. Wired connections are generally capable of transferring data at higher bandwidth data transfer rates than known wireless connections, but when used for VR or AR, wires can interfere with the user's experience of the VR or AR system by presenting a tripping hazard, limiting mobility, etc. Thus, conventional VR and AR systems either have the lower bandwidth data transfer rates and high latency that result from known wireless data transmission schemes, or they use wired data transmission that fails to provide a true immersive experience.

Turning now to an overview of the present invention, one or more embodiments provide VR and AR systems that incorporate high-throughput wireless visual data transmission. According to one or more embodiments, the high-throughput wireless data transmission is implemented as a high-speed visible light communication system, known as LiFi, and receiver system worn by a user to receive and process ultrahigh-definition visual data loads with low latency. In one or more embodiments, lower bandwidth positional data is offloaded to a standard wireless transmission path. In one or more embodiments, the LiFi and receiver system is implemented as an omnidirectional LiFi system where light is pulsed in all directions within a room and detected by an onboard line-of-sight receiver regardless of the receiver's location. In one or more embodiments, the LiFi and receiver system is implemented as an ultrahigh bandwidth directional laser-based LiFi system with dynamic user tracking.

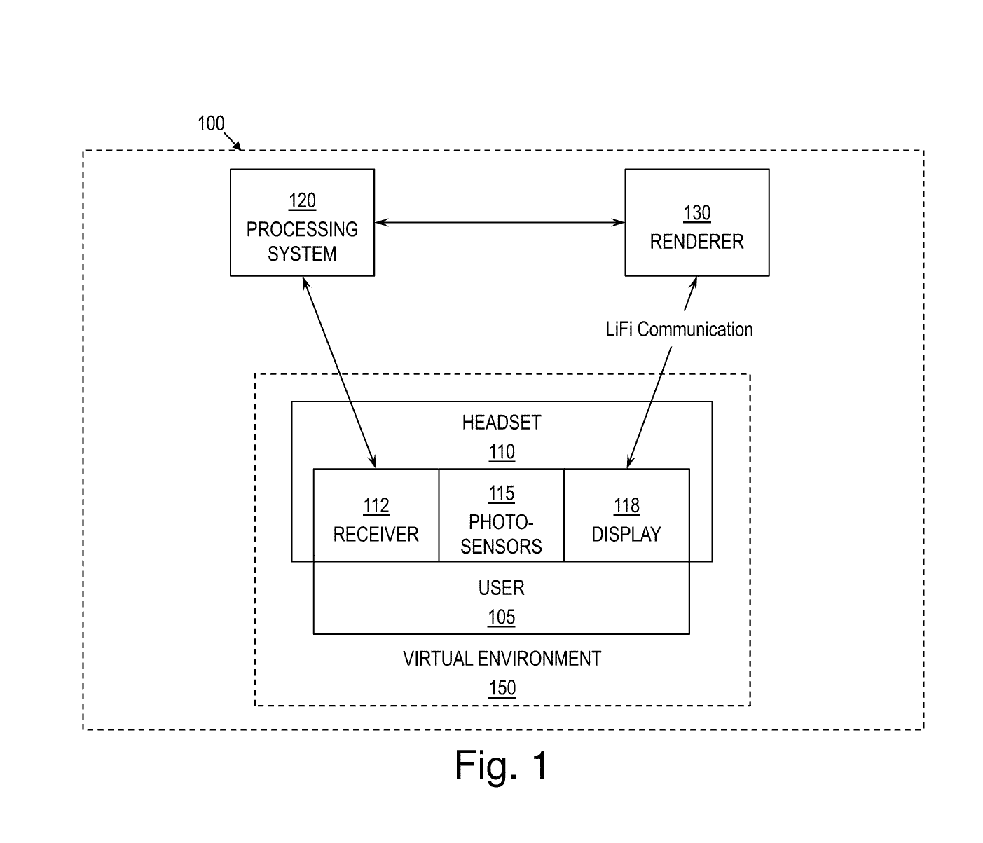

FIG. 1 is a block diagram of a display system 100, according to some embodiments of the present invention. As shown, the display system 100 may include a receiver 112, a processing system 120, a renderer 130, and a display 118. Generally, the receiver 112 may receive indication of a dynamic position of a user 105, so as to track the user 105; the processing system 120 may receive data from the receiver 112 and may simulate changes in the user's perspective of a virtual environment 150, reflecting a virtual or augmented reality, based on the user's position; and the renderer 130 may update the display 118 to reflect the user's new perspective. In some embodiments, the renderer 130 may be incorporated into the processing system 120.

In some embodiments, the user 105 may experience the virtual environment 150 by way of a headset 110, such as by the display 118 being incorporated into the headset 110. In this case, when the user 105 is wearing the headset 110, the user's view of objects outside of the display may be blocked by the headset 110, while the display 118 is visible. Further, in some embodiments, the receiver 112 may be attached to or integrated into the headset 110 or may be otherwise connected to the user, such that the user's position is equivalent to the receiver's position or is otherwise determinable based on the receiver's position. The receiver 112 may implement tracking technology used to determine its own position, and thus the user's position, in space (e.g., three-dimensional space) as the user 105 moves throughout the real world. With the receiver's position, the display system 100 may determine the receiver's, and thus the user's, virtual position in the virtual environment 150 and may cause the display 118 to display images that would reflect the user's virtual position in the virtual environment 150. The headset 110 may further include one or more photosensors 115, which may receive LiFi communications and may be in communication with the display 118.

The receiver 112 may determine tracking data, which may indicate the user's position in space. Various technologies known in the art may be used by the receiver 112 to determine the tracking data. The receiver 112, which may also be a transceiver, may transmit the tracking data to the processing system 120. This transmission may occur over various mechanisms of communication. For example, and not by way of limitation, wireless transmission such as WiFi, Bluetooth, or LiFi may be used to communicate the tracking data to the processing system 120.

The processing system 120 may determine the user's position in space based on the tracking data. In some embodiments, the receiver 112 will have detected the user's position. In that case, to determine the position, the processing system 120 may simply read the position provided in the tracking data. In some embodiments, however, the processing system 120 may calculate the user's position based on the tracking data. The mechanism for calculating the position based on the tracking data may depend on the form of the tracking data, and various mechanisms for determining position based on tracking data are well-known in the art.

As discussed above, the display system 100 may be a virtual-reality or augmented-reality system and may present to the user 105 an experience of a virtual environment 150 reflecting a virtual or augmented reality. As the user 105 moves in space, the display system 100 may simulate that movement within the virtual environment 150, and may present to the user's display 118 images reflecting what the user 105 would see if the movement occurred within the virtual environment 150. Thus, upon determining the user's position in space in the real world, the processing system 120 may translate that position into a corresponding position in virtual space, where the virtual space is the virtual environment 150.

Based on the position in virtual space, the renderer 130 may generate a set of one or more images of what the user 105 would see at the position within the virtual environment 150. In other words, the set of images may be based on the user's position in virtual space and may represent that position. The renderer 130 may be implemented with a graphics processing unit (GPU) in communication with the processing system 120. In some embodiments, the renderer 130 may render a distinct image for each eye, as the user's perspective may differ from eye to eye, given the different positions of each eye. Further, each image may be high-resolution (e.g., 720p, 1080i, 1080p, 4K resolution, or higher) to provide a realistic experience for the user 105.

In some embodiments, the renderer 130 may generate a new set of images, which may include one image per eye, at a sufficient speed to avoid simulator sickness. For example, and not by way of limitation, a set of images may be rendered at an MtP latency of no more than 20 ms. In other words, processes of the display system 100 between determining a current position of the user and presenting the set of the images to the user, where the set of images are based on that detected current position, may take no more than 20 ms, in some embodiments. Each set of images may be based on the user's current position in virtual space, which may be repeatedly or continuously updated as the user 105 moves in space in the real world.

The set of images may be transmitted to the display 118, so as to make the set of images visible to the user 105. Conventionally, this transmission presents significant issues, as wired transmission requires wires, which interrupt the virtual- or augmented-reality experience, and wireless transmission tends to be too slow to avoid simulator sickness when using high resolution.

According to some embodiments, however, transmission of the set of images to the display 118 occurs by way of LiFi wireless technology, which uses high-speed visible light transmission to communicate data. LiFi is capable of ultrahigh resolution transmission without wires. Specifically, LiFi plug-and-play transmitters may be used at, or in communication with, the renderer 130 to enable transmission of the set of images from the renderer 130 to the display 118. Further, in some embodiments, the LiFi transmitters are an array of light sockets arranged throughout the space to bathe the entire space in light.

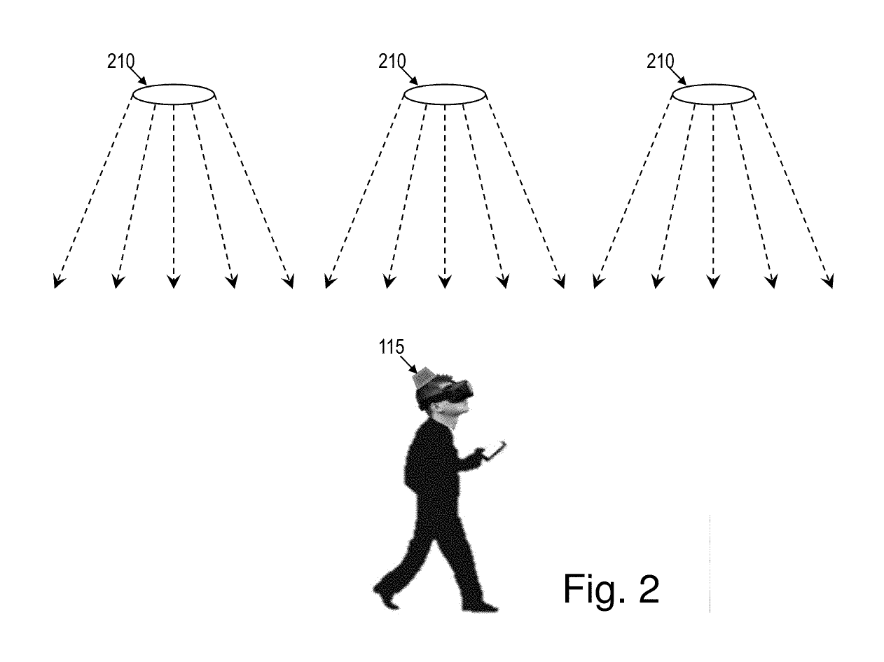

FIG. 2 is a diagram of a space for operation of the display system 100, according to some embodiments of this invention. Specifically, FIG. 2 illustrates an example use of LiFi for communicating data between the renderer 130 and the display 118.

As shown in FIG. 2, one or more LiFi transmitters 210 may be arranged throughout the space in which the user 105 is moving and may therefore light the space. The renderer 130 may communicate the set of images to the LiFi transmitters 210. The light transmitted by the LiFi transmitters 210 may thus include data representing the set of images. As mentioned above the headset 110 may include one or more photosensors 115. These photosensors 115 may receive the data transmitted by the LiFi transmitters 210. Generally, LiFi communication requires line-of-sight, and therefore, the LiFi transmitters 210 may be arranged to bathe the space in light. Further, the LiFi transmitters may be omnidirectional, to enable more effective spreading of the light throughout the space. As a result, the photosensors 115 may receive the LiFi data representing the set of images regardless of the user's position within the space.

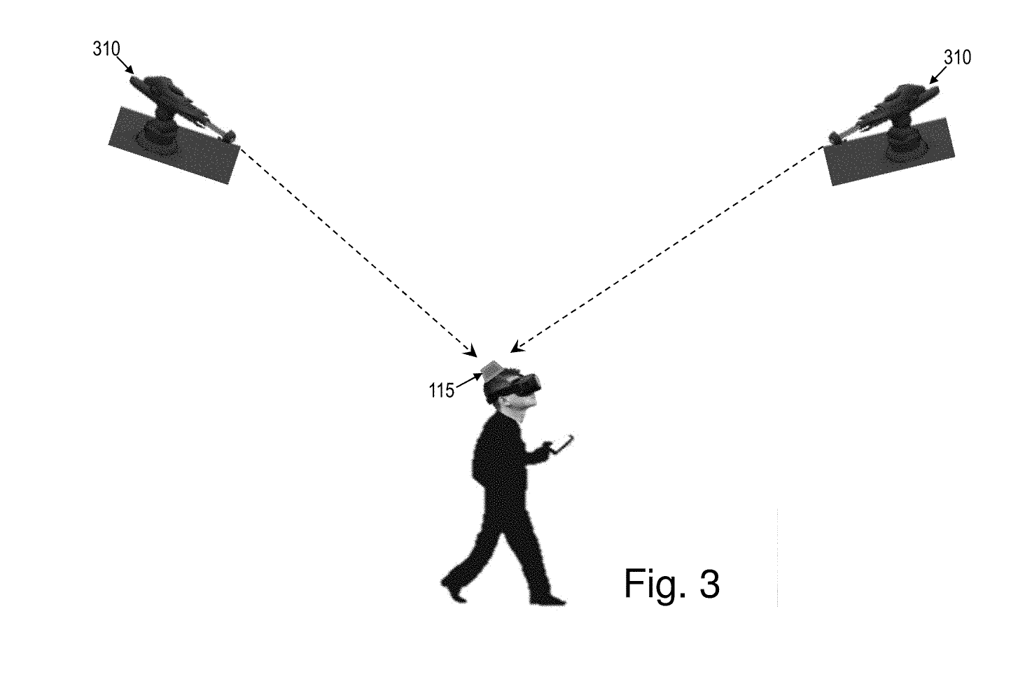

FIG. 3 is another diagram of a space for operation of the display system 100, according to some embodiments of this invention. Specifically, FIG. 3 illustrates another example use of LiFi for communicating data between the renderer 130 and the display 118.

As shown in FIG. 3, one or more laser-based LiFi transmitters 310 may be used in combination with position tracking. In contrast to the LiFi transmitters 210 of FIG. 2, the laser-based LiFi transmitters 310 may each shoot data, in the form of light, in a single direction. Specifically, the laser-based LiFi transmitters may shoot data representing the set of images, as received from the renderer 130. The direction of each laser-based LiFi transmitter may be modified automatically based on the user's position, which may be determined based on the tracking data as described above. Thus, the laser-based LiFi transmitters 310 may change direction as the user moves throughout the space. In some embodiments, more than a single laser-based LiFi transmitter 310 is used, thus increasing the chances that the photosensors 115 will receive the data representing the set of images.

The photosensors 115 may be in communication with the display 118, and may thus communicate the set of images to the display 118. The set of images may then be displayed to the user 105 through the display 118.

As the user 105 moves about space in the real world, the display system 100 may continuously or repeatedly track and thereby update the user's position in real space. This dynamic position of the user 105 in real space may then lead to continuous or repeated rendering of new sets of images for the user's eyes, as described above, which may be sent to the user's display 118. In some embodiments, the receiver 112 may provide streaming data of the user's dynamic position, and the display system 100 may use this streaming data to update the display 118 as needed, thereby enabling a virtual- or augmented-reality experience.

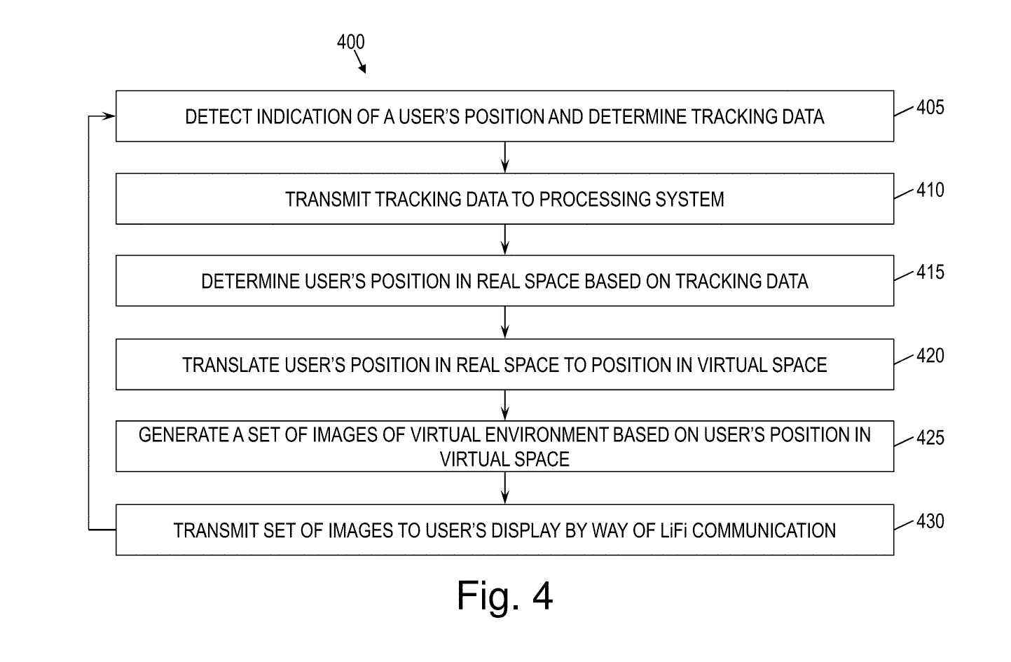

FIG. 4 is a flow diagram of a method 400 for simulating a virtual environment 150, according to some embodiments of this invention. More specifically, FIG. 4 summarizes the operations of the display system 100 described above.

As shown in FIG. 4, the method 400 begins at block 405, where the receiver 112 detects an indication of the user's position, and may determine tracking data based on that indication. At block 410, the receiver 112 transmits the tracking data to the processing system 120. At block 415, the processing system 120 may determine the user's position based on the tracking data. At block 420, the processing system 120 may translate the user's position in space in the real world to a position in virtual space, which is the virtual environment 150. At block 425, the renderer 130 may generate a set of images of the virtual environment 150, based on the user's position in virtual space. At block 430, one or more LiFi transmitters 210, 310 may transmit the set of images to the user's display 118, by way of LiFi transmission. It will be understood that the above method 400 may occur at streaming rate in some embodiments, and the user's display 118 may thus be updated as the user's position changes.

Embodiments of the display system 100 may be used in various applications. For example, and not by way of limitation, the display system 100 may be used to simulate dancing within a desired arena, such as on stage at the Bolshoi Theatre. When behaving as a user 105, a dancer cannot reasonably be expected to be connected to wires. If a wired connection were used, the dancer would have to reverse every rotation made during the dance, so as to keep the wires from becoming twisted. However, use of a conventional wireless virtual- or augmented-reality system would potentially cause simulator sickness, which would be particularly problematic given that the dancer would have to dance through that sickness. With some embodiments, however, the virtual environment 150 could reflect the desired dance stage without simulator sickness, while the sets of images rendered are delivered to the dancer's display 118 by way of LiFi communication.

For another example, and not by way of limitation, the display system 100 may be used to simulate a game, such as a game of duck-duck-goose. The user 105 may be a single player in the game, while one or more of the remaining players may be part of the virtual environment 150 and sharing real space with the user 105. For instance, some or all the other players may be located remotely and may use their own instances of the display system 100. Alternatively, all players may share a physical space, and the display system 100 may be used to simulate that the game takes place in a virtual location as the virtual environment. Through the use of LiFi for transmitting sets of images to the user's display 118, the display system 100 may enable the game to be played with high-resolution and without simulator sickness. Further, where multiple players are co-located, the lack of wires may avoid multiple players' wires becoming tangled together.

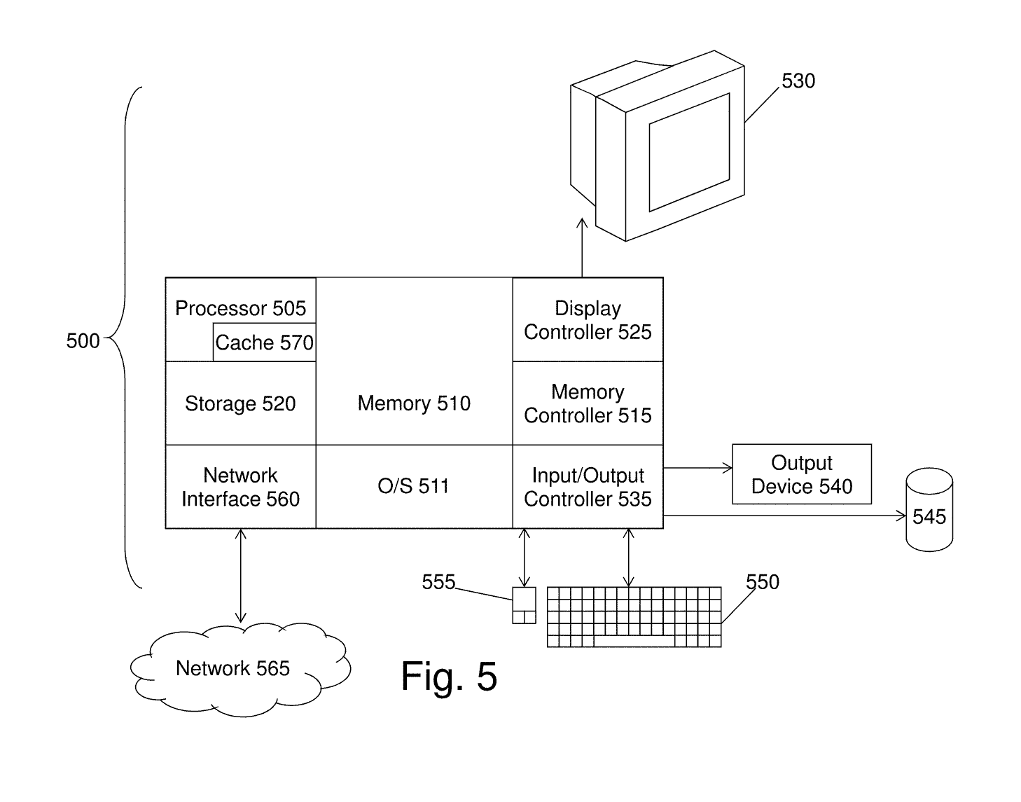

FIG. 5 illustrates a block diagram of a computer system 500 for use in implementing a display system 100 or method according to some embodiments. The display systems 100 and methods described herein may be implemented in hardware, software (e.g., firmware), or a combination thereof. In some embodiments, the methods described may be implemented, at least in part, in hardware and may be part of the microprocessor of a special or general-purpose computer system 500, such as a personal computer, workstation, minicomputer, or mainframe computer. For example, one or more of the receiver 112, the processing system 120, and the renderer may be computer system 500 or may be implemented by computer systems 500.

In some embodiments, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. Input devices such as a conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid state drive. The stored instructions in memory 510 or in storage 520 may include those enabling the processor to execute one or more aspects of the display systems 100 and methods of this disclosure.

The computer system 500 may further include a display controller 525 coupled to a monitor 530. In some embodiments, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In some embodiments, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Display systems 100 and methods according to this disclosure may be embodied, in whole or in part, in computer program products or in computer systems 500, such as that illustrated in FIG. 5.

Technical effects and benefits of some embodiments include the ability to create a realistic virtual environment 150, through the use of LiFi technology for transmitting images to a user's eyes. As a result of LiFi, simulator sickness may be avoided while providing high-resolution images to the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving, over a first transmission path, a position of a receiver in real space;
generating, by a computer processor, a set of images representing a position of the receiver in virtual space, wherein the position of the receiver in virtual space corresponds to the position of the receiver in real space; and
transmitting, over a second transmission path, using a light fidelity (LiFi) communication system, the set of images to a display, wherein the set of images are received by one or more photosensors in communication with the display;
wherein the second transmission path over which the set of images is transmitted has a higher bandwidth than the first transmission path over which the position of the receiver in real space is received.

2. The computer-implemented method of claim 1, wherein the set of images comprises one image per eye of a user, and wherein each image of the set of images is in high resolution.

3. The computer-implemented method of claim 2, wherein each image of the set of images is in at least 4K resolution.

4. The computer-implemented method of claim 3, further comprising:
repeating the receiving, the generating, and the transmitting while the receiver is in motion, wherein a motion-to-photon latency of the set of images being received at the display based on the position of the receiver is no greater than 20 milliseconds.

5. The computer-implemented method of claim 1, wherein receiving the position of the receiver in real space comprises receiving streaming data representing a dynamic position of the receiver in real space, and further comprising:
repeating the generating and the transmitting based on the dynamic position of the receiver.

6. The computer-implemented method of claim 1, wherein the receiving the position of the receiver in real space comprises tracking a dance of a user, and wherein the virtual space is a dance stage.

7. The computer-implemented method of claim 1, wherein the receiving the position of the receiver in real space comprises tracking play of a game, and wherein the virtual space is a virtual location of the game.

8. A system comprising:
a memory having computer readable instructions; and
one or more processors operably coupled to the memory to execute the computer readable instructions, the computer readable instructions comprising:
receiving, over a first transmission path, a position of a receiver in real space;
generating a set of images representing a position of the receiver in virtual space, wherein the position of the receiver in virtual space corresponds to the position of the receiver in real space; and
transmitting, over a second transmission path, using a light fidelity (LiFi) communication system, the set of images to a display, wherein the set of images are received by one or more photosensors in communication with the display;
wherein the second transmission path over which the set of images is transmitted has a higher bandwidth than the first transmission path over which the position of the receiver in real space is received.

9. The system of claim 8, wherein the set of images comprises one image per eye of a user, and wherein each image of the set of images is in high resolution.

10. The system of claim 9, wherein each image of the set of images is in at least 4K resolution.

11. The system of claim 10, the computer readable instructions further comprising:
repeating the receiving, the generating, and the transmitting while the receiver is in motion, wherein a motion-to-photon latency of the set of images being received at the display based on the position of the receiver is no greater than 20 milliseconds.

12. The system of claim 8, wherein receiving the position of the receiver in real space comprises receiving streaming data representing a dynamic position of the receiver in real space, and the computer readable instructions further comprising:
repeating the generating and the transmitting based on the dynamic position of the receiver.

13. The system of claim 8, wherein the receiving the position of the receiver in real space comprises tracking a dance of a user, and wherein the virtual space is a dance stage.

14. The system of claim 8, wherein the receiving the position of the receiver in real space comprises tracking play of a game, and wherein the virtual space is a virtual location of the game.

15. A computer program product for simulating a virtual environment, the computer program product comprising a computer readable storage medium having program instructions embodied therewith, the program instructions executable by a processor to cause the processor to perform a method comprising:
receiving, over a first transmission path, a position of a receiver in real space;
generating a set of images representing a position of the receiver in virtual space, wherein the position of the receiver in virtual space corresponds to the position of the receiver in real space; and
transmitting, over a second transmission path, using a light fidelity (LiFi) communication system, the set of images to a display, wherein the set of images are received by one or more photosensors in communication with the display;
wherein the second transmission path over which the set of images is transmitted has a higher bandwidth than the first transmission path over which the position of the receiver in real space is received.

16. The computer program product of claim 15, wherein the set of images comprises one image per eye of a user, and wherein each image of the set of images is in at least 4K resolution.

17. The computer program product of claim 16, the method further comprising:
repeating the receiving, the generating, and the transmitting while the receiver is in motion, wherein a motion-to-photon latency of the set of images being received at the display based on the position of the receiver is no greater than 20 milliseconds.

18. The computer program product of claim 15, wherein receiving the position of the receiver in real space comprises receiving streaming data representing a dynamic position of the receiver in real space, and the method further comprising:
repeating the generating and the transmitting based on the dynamic position of the receiver.

19. The computer program product of claim 15, wherein the receiving the position of the receiver in real space comprises tracking a dance of a user, and wherein the virtual space is a dance stage.

20. The computer program product of claim 15, wherein the receiving the position of the receiver in real space comprises tracking play of a game, and wherein the virtual space is a virtual location of the game.

21. A computer-implemented method, comprising:
generating tracking data describing a dynamic position of a receiver in real space;
directing a laser-based light fidelity (LiFi) transmitter to follow the receiver, wherein the directing comprises:
detecting, by a first wireless transmission path, a change in the dynamic position of the receiver; and
modifying a direction of the LiFi transmitter to follow the receiver, responsive to the change in the dynamic position of the receiver;
generating, by a computer processor, a set of images representing a position of the receiver in virtual space, wherein the position of the receiver in virtual space corresponds to the position of the receiver in real space; and
transmitting, over a second transmission path, using the laser-based LiFi transmitter following the receiver, the set of images to a display;
wherein the second transmission path over which the set of images is transmitted has a higher bandwidth than the first transmission path over which the change in the dynamic position of the receiver is detected.

22. The computer-implemented method of claim 21, wherein the transmitting the set of images to the display comprises transmitting LiFi data from the LiFi transmitter to one or more photosensors in communication with the display.

23. The computer-implemented method of claim 22, wherein the one or more photosensors and the display are integrated into a headset.

24. A computer-implemented method, comprising:
receiving, over a first transmission path, tracking data describing a dynamic position of a receiver in real space;
generating, by the computer processor, a set of images representing a position of the receiver in virtual space, wherein the position of the receiver in virtual space corresponds to the position of the receiver in real space;
transmitting the set of images to a plurality of omnidirectional light fidelity (LiFi) transmitters, each of the omnidirectional LiFi transmitters being configured to provide omnidirectional LiFi data; and
transmitting, over a second transmission path, using the plurality of omnidirectional LiFi transmitters, the set of images to one or more photosensors in communication with a display;
wherein the second transmission path over which the set of images is transmitted has a higher bandwidth than the first transmission path over which the change in the dynamic position of the receiver is received.

25. The computer-implemented method of claim 24, wherein the one or more photosensors and the display are integrated into a headset.
